(19) United States
(12) Patent Application Publication
(10) Pub. No.: US 2010/0037433 A1
(43) Pub. Date: Feb. 18, 2010

(54) HANDLE FOR EXERCISE EQUIPMENT INCORPORATING A FEATURE FOR ADJUSTING LENGTH OF AN ATTACHED CORD

(76) Inventor: Brett Clyde Walker, Provo, UT (US)

Correspondence Address: ANGUS C. FOX, III, 4093 N. IMPERIAL WAY, PROVO, UT, 84604-5386, US

(21) Appl. No.: 12/541,154

(22) Filed: Aug. 13, 2009

Related U.S. Application Data
(60) Provisional application No. 61/088,404, filed on Aug. 13, 2008.

(51) Int. Cl. B25G 1/10

(52) U.S. Cl. 16/421

(57) ABSTRACT

A handle for exercise equipment provides for adjustment in length of the cord to which it is secured. The handle is generally C-shaped, such that first and second extensions, each of which incorporates a tubular channel, extend in a forward direction from opposite ends of a handgrip portion of the handle. A rear surface of the handgrip element incorporates a generally rectangular recess that extends between the two tubular channels. A rectangular plug, which snaps into the rectangular recess, is equipped with a generally cylindrical bore that extends the length of the rectangular plug. In order to attach the cord to the handle, it is routed through the cylindrical bore of the rectangular plug, and then through each of the tubular channels. In order to shorten the effective length of the cord, the plug is removed, reversed in direction and replaced in the recess.₍₁₄₅₎

This application for patent has a priority based on the filing of provisional patent application No. 61/088,404, titled HANDLE FOR EXERCISE EQUIPMENT INCORPORATING AN ADJUSTMENT FOR CORD LENGTH, which was filed on Aug. 13, 2008.

### FIELD OF THE INVENTION

The present invention relates, generally, to handles for exercise equipment and, more specifically, to handles having a feature which adjusts the length of an attached cord or cords.

### BACKGROUND OF THE INVENTION

Exercise equipment is frequently equipped with handles which are attached via cords to force-producing items, such as weights or flexible members. As there is considerable variety in body sizes of human beings, there is a need for adjustability of the length of the attachment cords.

U.S. Pat. No. 6,482,137 to the same inventor, Brett C. Walker, discloses a spinning exercise device that is manipulated by the user with a pair of opposed handles, and to which weights may be added to increase the level of exercise of the user. This patent is incorporated herein, by reference, in its entirety. The spinning exercise device comprises a disk and associated tethers. The disk is configured and disposed so as to receive two or more tethers on opposing sides of the disk. The tethers are wound or coiled upon the spinning of the disk. The coiling of the tethers shortens the length of the tethers and resists the spinning of the disk until the disk is slowed to a stop and whereupon the disk begins spinning in the opposite direction to unwind or uncoil the tethers. If the user exerts outward force upon the tethers away from the disk, the uncoiling of the tethers and spinning of the disk are accelerated. The spinning of the disk accelerates in the new direction until the winding of the tethers is undone and the tethers begin to be wound in the opposite direction again resisting the spinning of the disk until the disk comes to a stop and begins spinning again in the opposite direction. This is repeated over and over. As the disk spins and the tethers are wound or coiled, the length of the tethers decreases and the ends of the tether not attached to the disk are drawn inward. The user may derive exercise from using the device by resisting the force shortening the length of the tethers as the tethers are wound by the spinning disk and by exerting outward force against the tethers to slow or reverse the spin of the disk or to accelerate the spin of the disk to unwind the tethers. The disk is also disposed to receive additional weight such that the momentum of the spinning disk may be increased or decreased to suit the exercise level of the user.

Although multiple cord, or tether, sets may be provided to accommodate different-sized users, it would be desirable to simply shorten or lengthen a single set of tethers, as needed.

### SUMMARY OF THE INVENTION

The present invention provides a handle for exercise equipment that provides for adjustment in length of the cord to which it is secured. The handle, which is generally C-shaped, such that first and second extensions extend in a forward direction from opposite ends of a handgrip element of the handle. Each of the extensions includes an internal passageway, which is a generally tubular channel having a diameter that is at least as large as the diameter of a cord or rope to which the handle is attached. Each of the tubular channels is optionally accessible along the outer periphery thereof via a slot that communicates with each tubular channel. The slot has a width that is less than that of the diameter of the cord so that the cord must be deformed in order to pass it through the slot into the tubular channel. Once completely within the channel, the cord slides freely within the channel. The slots may be eliminated entirely, if desired, so that the cord must be threaded through each tubular channel. A rear surface of the handgrip element of the handle has a generally rectangular recess that extends between the two tubular channels. A rectangular plug, which snaps into the rectangular recess, is equipped with a generally cylindrical bore that extends the length of the rectangular plug. In order to attach the cord to the handle, it is routed through the cylindrical bore of the rectangular plug, and then through each of the tubular channels. The cylindrical bore can be replaced with a longitudinal passageway that is accessible through an installation slot. In either case, with the rectangular plug snapped into the rectangular recess, each end of the cord exits a different tubular channel, with the cord being effectively enclosed within the handle. In order to effectively shorten the length of the cord, the rectangular plug is removed from the rectangular recess, and replaced within the rectangular recess in reversed direction, thereby effectively reducing the length of the cord by an amount equal to double the length of the rectangular plug. The original length of the cord can be restored by again removing the plug from the recess and returning it to its original orientation. In order to provide clearance for the cord as the rectangular plug is snapped into the rectangular recess, an aperture is positioned at each end of the rectangular recess.

### BRIEF DESCRIPTION OF THE DRAWINGS

FIG. 1 is an exploded, isometric view of the handle;

FIG. 2 is an exploded, elevational side view of the handle;

FIG. 3 is an assembled, isometric view of the handle;

FIG. 4 is an assembled, elevational side view of the handle;

FIG. 5 is an exploded, see-through side view of the handle;

FIG. 6 is an assembled, see-through side view of the handle;

FIG. 7 is an exploded, see-through view of the handle with the rectangular plug removed from the rectangular recess of the handgrip element of the handle, and with an installed cord configured for maximum length;

FIG. 8 is an assembled, see-through view of the handle, with an installed cord configured for maximum length;

FIG. 9 is an exploded, see-through view of the handle, with the rectangular plug removed from the handgrip element of the handle and an installed cord twisted 180 degrees;

FIG. 10 is an assembled, see-through side view of the handle, with an installed cord configured for minimum length following execution of the operational steps depicted in FIGS. 7 and 9;

FIG. 11 is an assembled, isometric view of the handle having an alternative embodiment rectangular plug; and

FIG. 12 is a cross-sectional view of the alternative embodiment rectangular plug, taken through the center thereof.

### PREFERRED EMBODIMENT OF THE INVENTION

The present invention provides a handle for exercise equipment that provides for adjustment in length of the pair of cords to which it is attached. The handle and its functionality will now be described in detail with reference to the attached drawing figures.

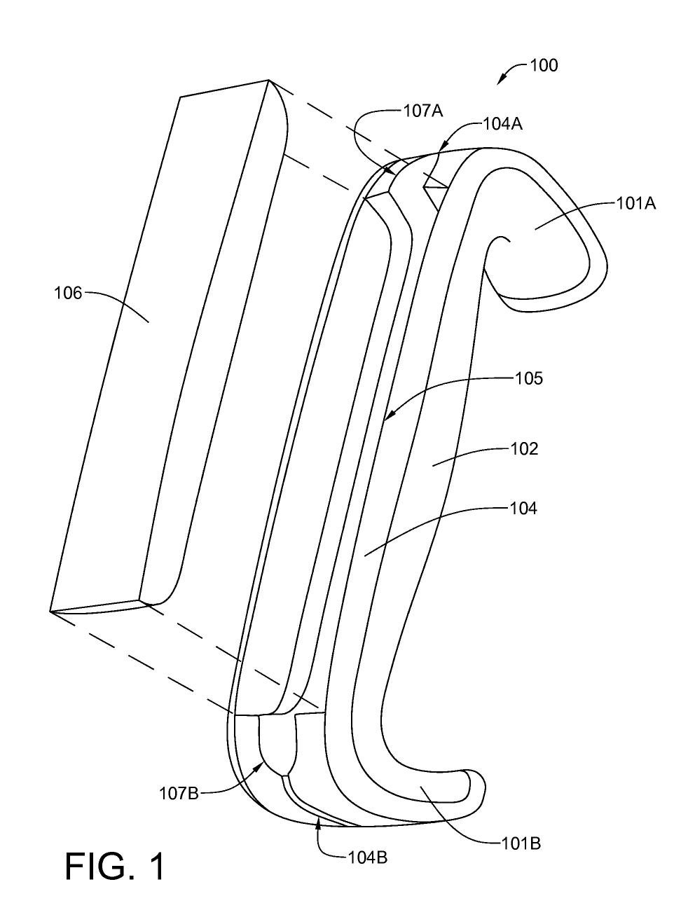

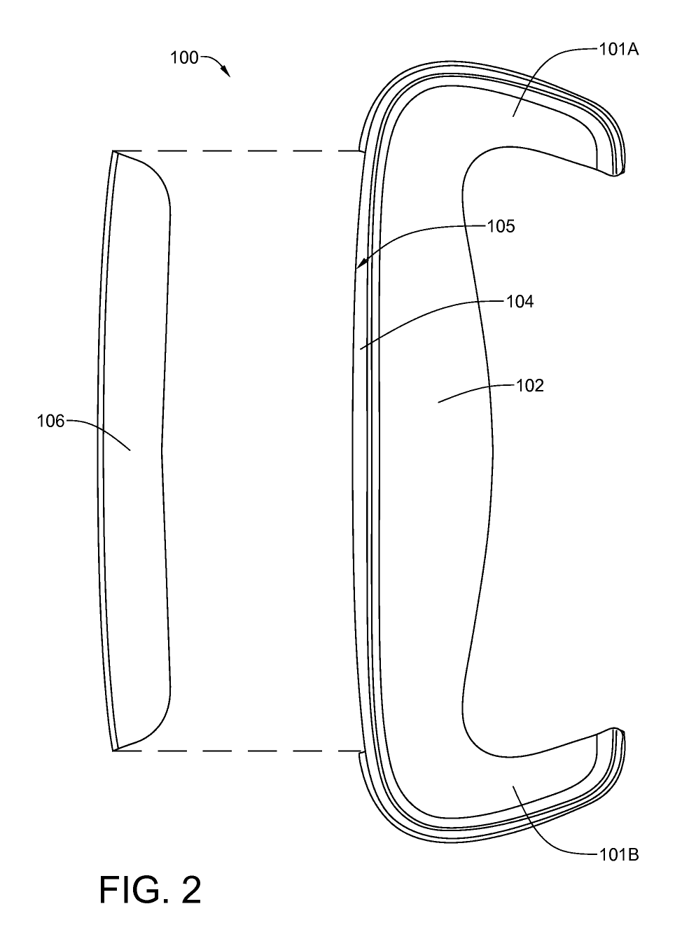

Referring now to FIGS. 1 and 2, the new handle for exercise equipment 100 is generally C-shaped, having first and second extensions 101A and 101B which extend in a forward direction from opposite ends of a handgrip element 102 of the handle 100. The handgrip element 102 and the first and second extensions 101A and 101B together form a unitary C-shaped structure. Each of the extensions 101A and 101B incorporates a generally tubular channel therein, each of which has a diameter that is slightly larger than the diameter of a cord or rope to which the handle is attached. Each of the tubular channels, which are not visible in this view, is optionally accessible along the outer periphery thereof via first and second installation slots 103A and 103B, respectively, each of which communicates with one of the tubular channels. Each installation slot 103A or 103B has a width that is less than that of the diameter of the cord so that the cord must be deformed in order to pass it through the slot into the tubular channel. Once completely installed with a tubular channel, the cord (not shown in this view) slides freely within the tubular channel. The slots may be eliminated entirely, if desired, so that the cord must be threaded through each tubular channel. A rear surface 104 of the handgrip element 102 of the handle 100 has a generally rectangular recess 105 that extends, generally, between the two tubular channels. A rectangular plug 106, which snaps into the rectangular recess 105, is equipped with a generally cylindrical bore (not shown in this view) that extends the length of the rectangular plug 106. In order to attach the cord to the handle, the cord is routed through the cylindrical bore of the rectangular plug, and then through each of the tubular channels. With the rectangular plug 106 snapped into the rectangular recess 105, each end of the cord exits a different tubular channel, with the cord being effectively enclosed within the handle. In order to effectively shorten the length of the cord, the rectangular plug 106 is removed from the rectangular recess 105, and replaced within the rectangular recess 105 in reversed direction, thereby effectively reducing the length of the cord by an amount equal to double the length of the rectangular plug 106. In order to provide clearance for the cord as the rectangular plug 106 is snapped into the rectangular recess 105, a first aperture 107A is positioned at one end of the rectangular recess 105 adjacent the first slot 103A, and a second aperture 107B is positioned at the opposite end of the rectangular recess 105 adjacent the second slot 103B. The original length of the cord can be restored by again removing the plug 106 from the recess 105 and returning it to its original orientation.

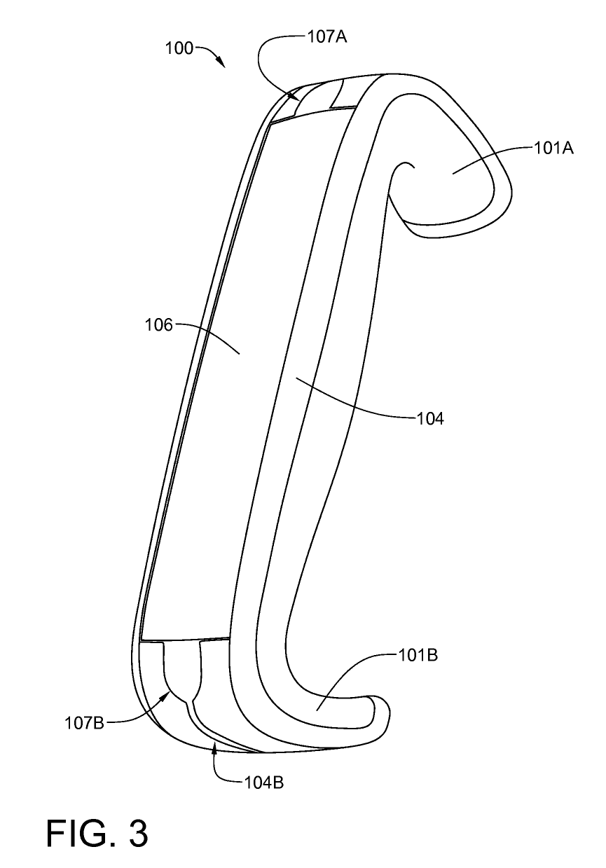

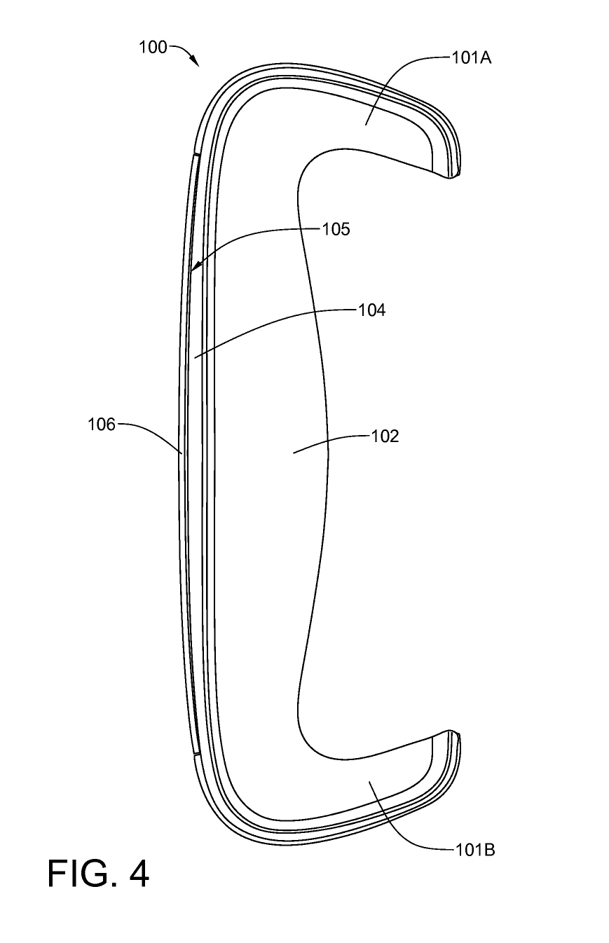

Referring now to FIGS. 3 and 4, the handle 100 of FIGS. 1 and 2 is shown with the rectangular plug 106 snapped into the rectangular recess 105.

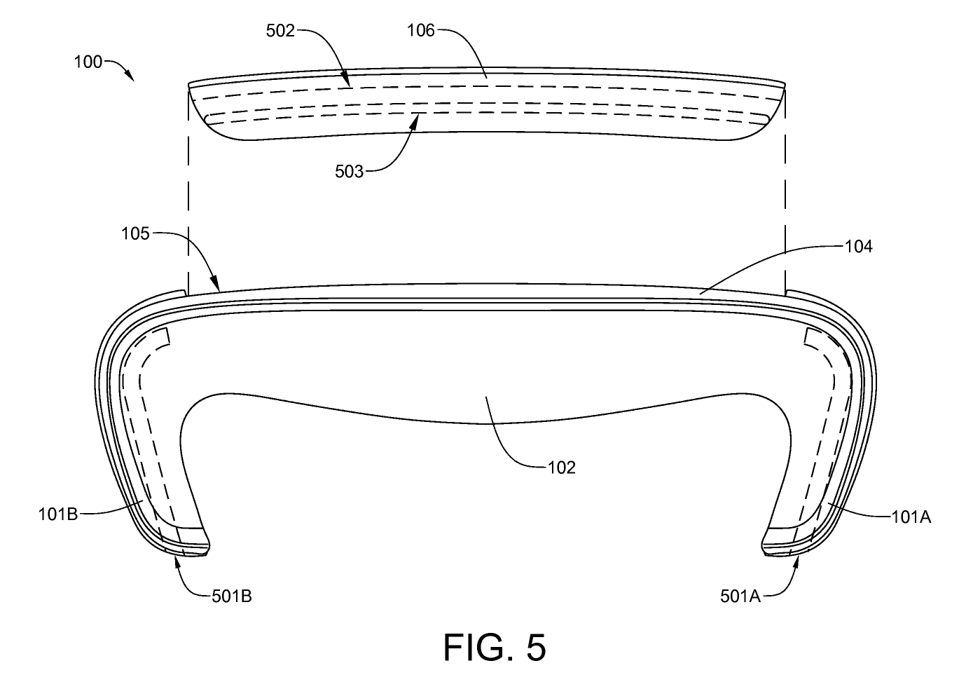

Referring now to FIG. 5, the handle 100 is shown in an exploded see-through view so that the tubular channels 501A and 501B in each of the extensions 101A and 101B, respectively, as well as the tubular cylindrical bore 502 in the rectangular plug 106 are visible. It will be noted that there is also a longitudinal groove 503 below the cylindrical bore 502. When the rectangular plug 106 is reversed to effectively shorten the attached cord, portions of the cord are positioned within the longitudinal groove 503. The longitudinal groove 503 is sufficiently wide to accommodate two side-by-side portions of the cord.

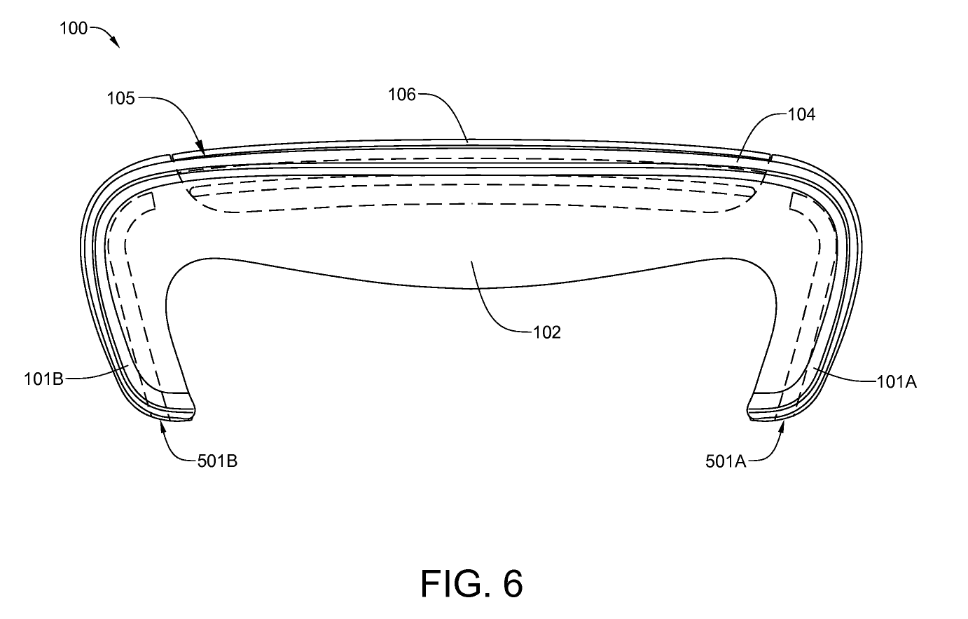

Referring now to FIG. 6, the handle 100 is shown in an assembled configuration. It will be noted that the end of each tubular channel 501A and 401B adjacent the rectangular recess 105 is positioned between the ends the tubular cylindrical bore 502 and the longitudinal groove 503 in order to minimize the offset between a tubular channel 501A or 501B and the ends of the cylindrical bore 502 and longitudinal groove 503, whether the rectangular plug 106 is positioned normally or reversed within its rectangular recess 105.

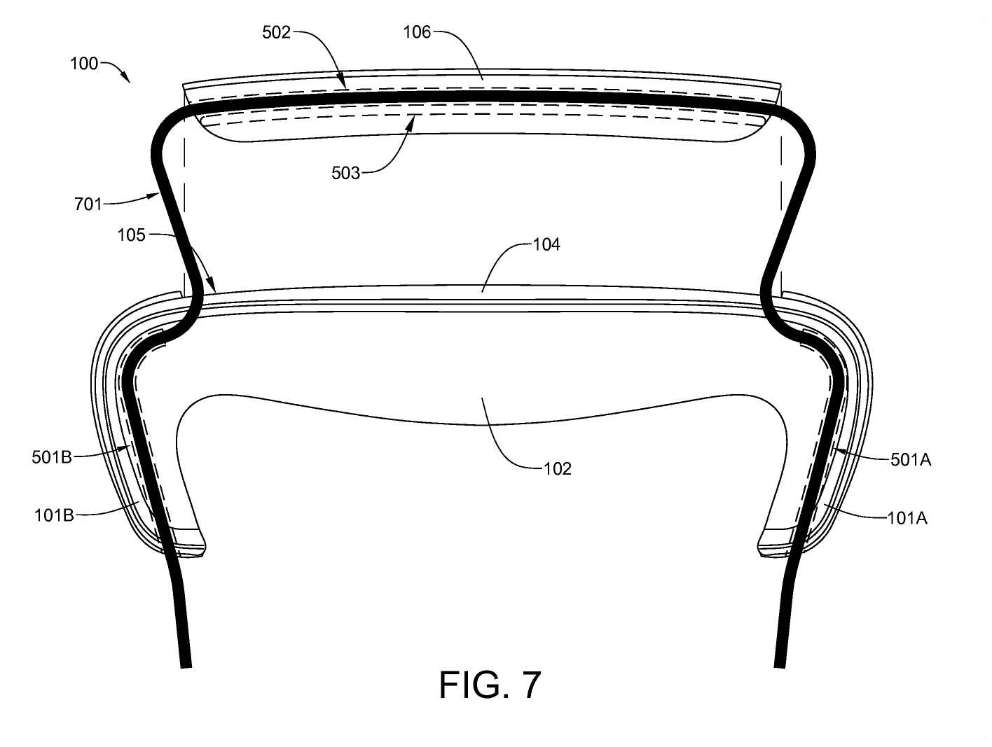

Referring now to FIG. 7, in this view of the handle 100 with the rectangular plug 106 removed from the rectangular recess 105, a cord 701 is routed through the cylindrical bore 502 of the rectangular plug 106 and through each of the tubular channels 501A and 401B. This is the routing used for maximum cord length. The cord may be constructed of fibers made of synthetic polymer fibers such as nylon, para-aramid (Kevlar®), polypropylene, glass fibers, other manmade materials, rubber, leather, natural fibrous materials such as hemp, sisal, and the like, as well as combinations of different materials. The cord may be of a wound, braided, woven, or extruded composite, or monofilament configuration.

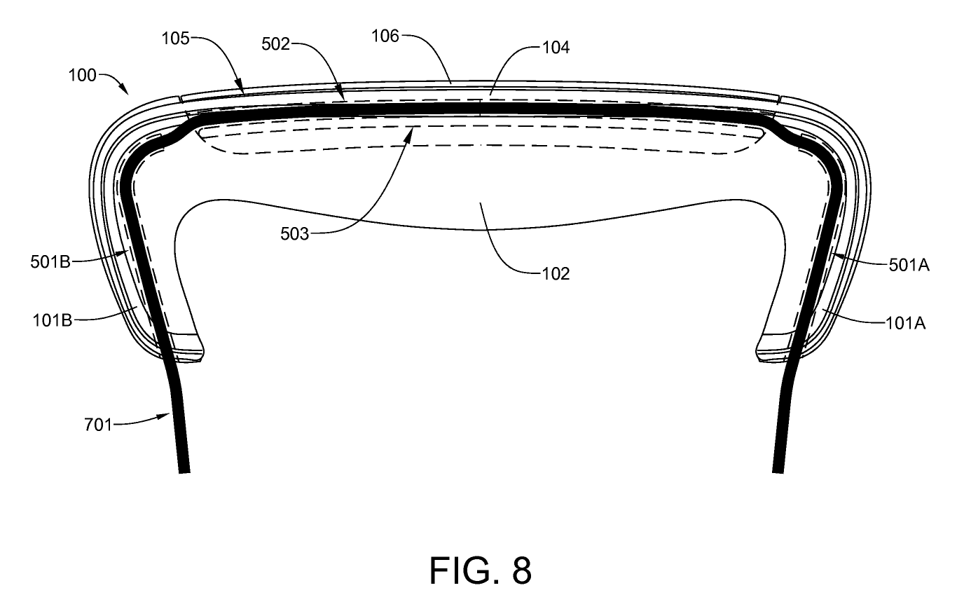

Referring now to FIG. 8, using the cord routing of FIG. 7, the rectangular plug 106 has been snapped into the rectangular recess 105, thereby providing a cord-routing configuration for maximum cord length.

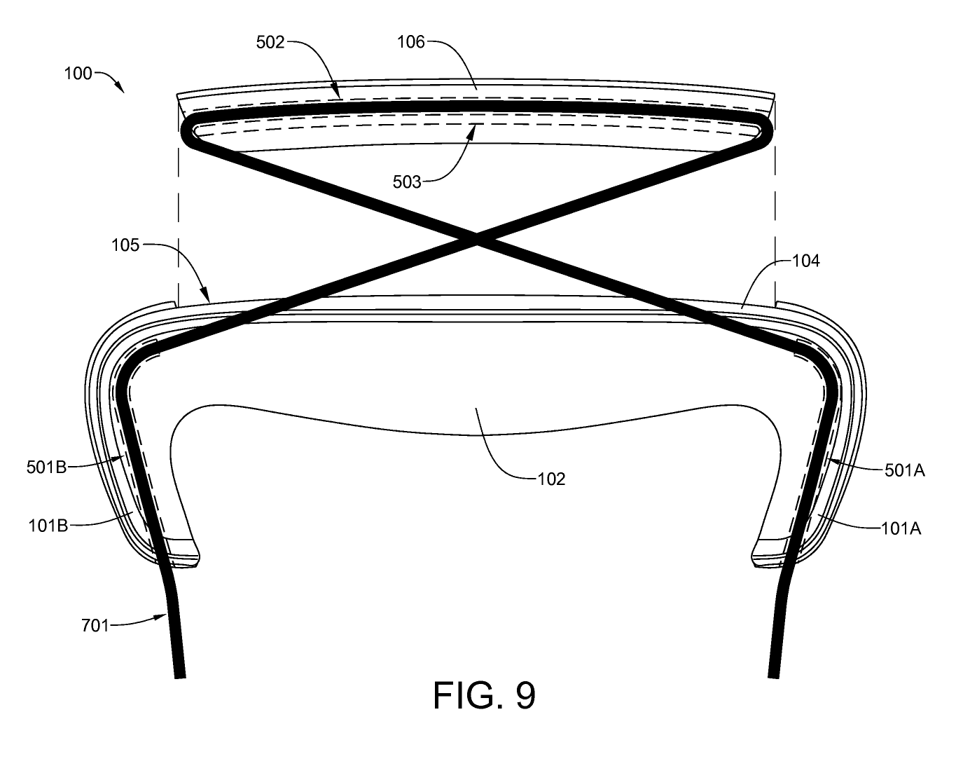

Referring now to FIG. 9, in this view of the handle 100 with the rectangular plug 106 removed from the rectangular recess 105, the cord routing of FIG. 7 has been altered by reversing the position of the rectangular plug 106 and simultaneously twisting the cord 701 so that there is effectively three times the amount of cord stored within the rectangular recess 105.

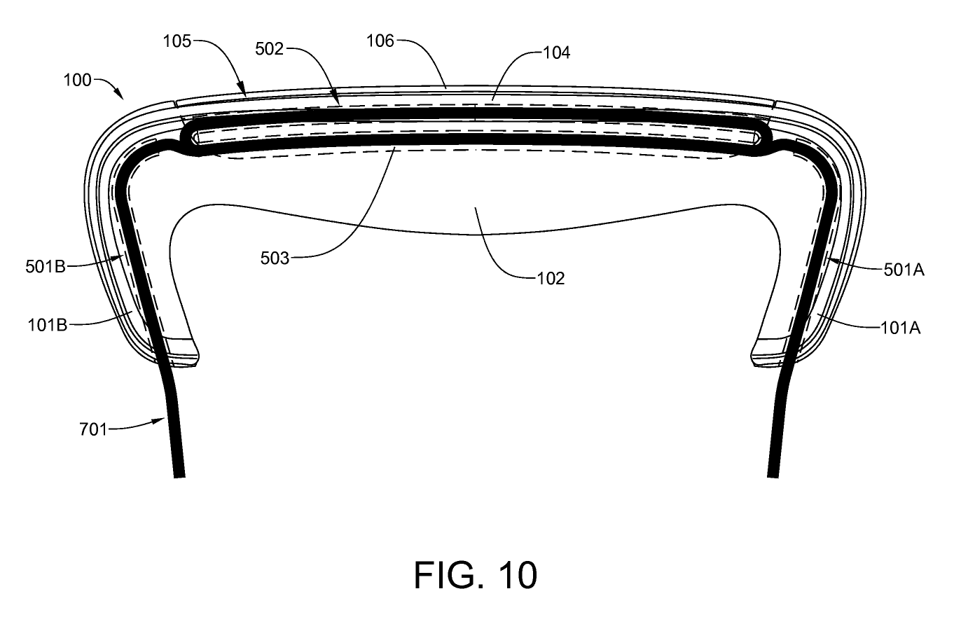

Referring now to FIG. 10, using the cord routing of FIG. 9, the rectangular plug 106 has been snapped into the rectangular recess 105, thereby providing a cord-routing configuration for minimum cord length. The extra cord taken up by the reversal of the rectangular plug 106 is stored as two side-by-side portions within the longitudinal groove 503.

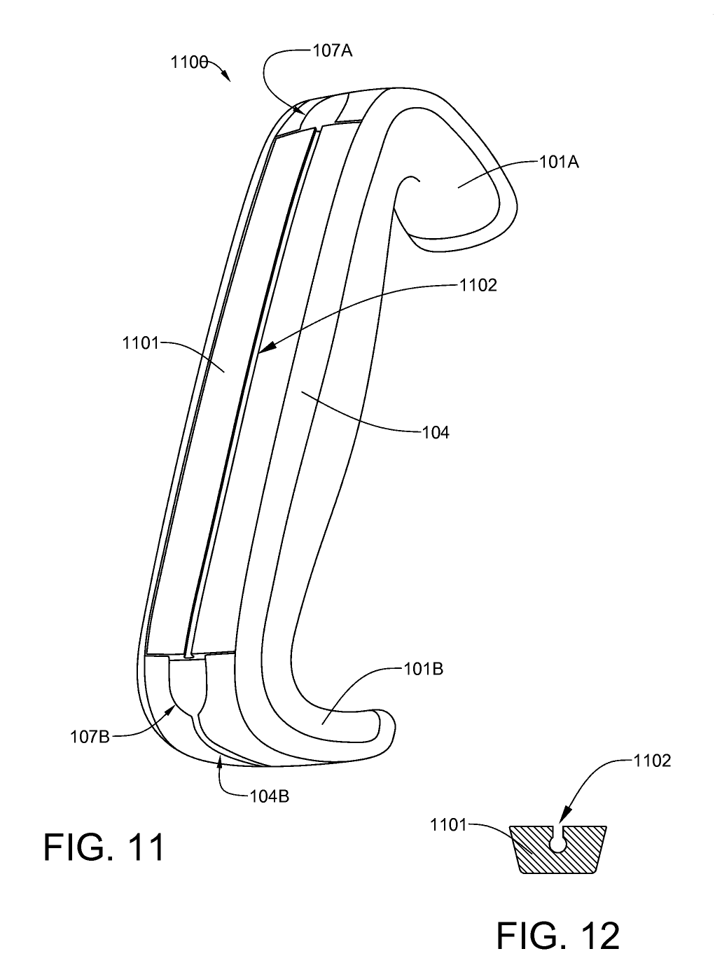

Referring now to FIG. 11, a handle 1100 having an alternative embodiment rectangular plug 1101 is shown. Instead of having a cylindrical bore 502 running longitudinally through the plug 1101, it is equipped with a channel shaped like the tubular channels 501A and 501B.

In order to anchor the paid of cords emanating from the handle 100 between a hinged door edge and a door frame, the plug 106 or 1101 can be removed and separated from said unitary C-shaped structure so that the plug and attached cord portions can be inserted between the hinged edge of the door and the adjacent door frame. The door is then carefully closed, the C-shaped structure on an opposite side of the door so as to protect the door from abrasion from the cord as it twists during operation of the spinning exercise device. In addition, the plug 106 or 1101, along with the attached cord portions, can be used to anchor the two chord portions to other equipment by simply creating a recess or pocket in which the plug 106 or 1101 securely fits.

A presently preferred embodiment of the invention has been injection molded from thermoplastic elastomer (TPE) material. TPEs are a family of polymers that can be repeatedly stretched without permanently deforming the shape of the part. Unlike rubber-like elastomers, they do not require curing or vulcanization, as they are true thermoplastics. TPEs may be processed by conventional thermoplastic techniques such as injection molding, extrusion and blow molding. Thermoplastic elastomers have replaced rubber in many applications. There are six main commercially-available thermoplastic elastomer groups: styrenic block copolymers, polyolefin blends (TPOs), elastomeric alloys, thermoplastic polyurethanes (TPUs), thermoplastic copolyesters and thermoplastic polyamides. Although a polypropylene blend was used for the presently preferred embodiment, other TPEs may also be used with success.

Although only several embodiments of the new handle for exercise equipment have been described herein, it should be obvious to those having ordinary skill in the art that changes and modifications may be made thereto without departing from the scope and the spirit of the invention as hereinafter claimed.

What is claimed is:

1. An exercise equipment handle comprising:
a longitudinal handhandgrip element having a recess centered within a rear surface thereof, said recess extending substantially an entire length of said longitudinal handhandgrip element;
first and second forward extensions unitary with said longitudinal handhandgrip element, which extend forward from opposite ends of said longitudinal handhandgrip element, each extension incorporating an internal passageway beginning at a first opening at a front end of each forward extension and extending to a second opening at the rear of said handhandgrip element, each second opening being directly behind an associated forward extension and adjacent one end said recess; and
a plug, which fits into said recess, said plug having a longitudinal passageway therethrough, such that a cord can be routed through the internal passageway in the first extension, through the longitudinal passageway in the plug and, then, through the internal passageway in the second extension, and whereby the plug can be removed from said recess, rotated 180 degrees so that a length of cord is pulled through the internal passageway of each forward extension and folded beneath said plug, resulting in a shorting of an exposed length of the cord extending from each forward extension.

2. The exercise equipment handle of claim 1, wherein each internal passageway is exposed along a major portion of its length by a slot having a width that is less than a diameter of the cord routed therethrough, such that the cord can be forced into the passageway by temporarily deforming the cord as it is pulled through the slot.

3. The exercise equipment handle of claim 1, wherein said longitudinal handhandgrip element and said first and second forward extensions are injection molded from a thermoplastic elastomer.

4. The exercise equipment handle of claim 3, wherein said thermoplastic elastomers are selected from the group consisting of styrenic block copolymers, polyolefin blends, elastomeric alloys, thermoplastic polyurethanes, thermoplastic copolyesters and thermoplastic polyamides.

5. The exercise equipment handle and cord assembly of claim 1, wherein the two forward extensions are angled toward one another.

6. The exercise equipment handle of claim 5, wherein each forward extension forms an angle with the longitudinal handhandgrip element of about 60 degrees.

7. The exercise equipment handle of claim 1, wherein each internal passage way has a width that is at least as wide as a diameter of the cord.

8. An exercise equipment handle and cord assembly comprising:
a generally C-shaped unitary structure having a pair of extension elements emanating in a generally forward direction from opposite ends of a handhandgrip element, said handhandgrip element having a recess centered within a rear surface thereof, said unitary C-shaped structure having a cord installation groove that extends around a portion of an outer periphery, said installation groove being discontinuous through the recess;
a plug, which fits into said recess, said plug having a longitudinal passageway therethrough; and
a cord routed through the installation groove of each extension element and through the longitudinal passageway in the plug, such that the cord extends from a free end of each extension element, and whereby the plug can be removed from said recess and rotated 180 degrees so that a length of cord is pulled through the installation groove of each extension element and folded beneath said plug, resulting in a shortening of each section of exposed cord which is not trapped within the unitary structure, when said plug is reinserted in said recess.

9. The exercise equipment handle and cord assembly of claim 8, wherein the two extension elements are angled toward one another.

10. The exercise equipment handle of claim 9, wherein each extension element forms an angle with the handhandgrip element of about 60 degrees.

11. The exercise equipment handle of claim 8, wherein said recess extends substantially an entire length of said handhandgrip element;

12. The exercise equipment handle of claim 8, wherein said longitudinal handhandgrip element and said first and second forward extensions are injection molded from a thermoplastic elastomer.

13. The exercise equipment handle of claim 12, wherein said thermoplastic elastomers are selected from the group consisting of styrenic block copolymers, polyolefin blends, elastomeric alloys, thermoplastic polyurethanes, thermoplastic copolyesters and thermoplastic polyamides.

14. The exercise equipment handle of claim 8, wherein said cord installation groove is narrower at a mouth thereof than in a trough thereof, said mouth having a width that is less than a diameter of the cord, and said trough having a width that is at least as wide as the diameter of the cord.

15. The exercise equipment handle of claim 8, wherein a major portion of an inner periphery of said unitary C-shaped structure is ribbed to enhance handgripability.

16. The exercise equipment handle of claim 8, wherein said plug and an attached portion of the cord can be removed and separated from said unitary C-shaped structure so that the plug and attached cord portion can be inserted between a hinged edge of a door and an adjacent door frame, and the door subsequently closed with the C-shaped structure on an opposite side of the door so as to protect the door from abrasion from the cord as it twists during operation of the spinning exercise device.
